(19) United States
(12) Patent Application Publication
(10) Pub. No.: US 2010/0085760 A1
(43) Pub. Date: Apr. 8, 2010

(54) ILLUMINANT DEVICE AND LIGHT REFLECTING SHADE THEREOF

(76) Inventors: Han-Chung HSU, Taoyuan Hsien (TW); Nai-Yueh Liang, Taoyuan Hsien (TW)

Correspondence Address: Muncy, Geissler, Olds & Lowe, PLLC, P.O. BOX 1364, FAIRFAX, VA, 22038-1364, US

(21) Appl. No.: 12/345,089

(22) Filed: Dec. 29, 2008

(30) Foreign Application Priority Data
Oct. 8, 2008 (TW) 097138624

(51) Int. Cl. F21V 1/00; F21V 7/09

(52) U.S. Cl. 362/296.05; 362/241

(57) ABSTRACT

This invention provides an illuminant device and its light reflecting shade for reflecting a light emitted from a light source. The light reflecting shade includes at least one reflecting sheet, which forms a conoid-like structure having a first side and a second side. The light source is disposed at the first side, and the second side is a light emitting side. The central axial line of the first side is aligned or not aligned with the central axial line of the second side.

### CROSS REFERENCE TO RELATED APPLICATIONS

This Non-provisional application claims priority under 35 U.S.C. §119(a) on Patent Application No(s). 097138624 filed in Taiwan, Republic of China on Oct. 8, 2008, the entire contents of which are hereby incorporated by reference.

### BACKGROUND OF THE INVENTION

1. Field of Invention

The present invention relates to an illuminant device and its light reflecting shade and, in particular, to a light reflecting shade having a high directivity and capable of concentrating the light in the specified area.

2. Related Art

The mercury lamp, high pressure sodium (HPS) lamp, or metal halide lamp with a hemispheric light shade are usually used as the conventional street illuminant device. FIGS. 1A and 1B are the schematic views of a conventional hemispherical light shade. With reference to FIGS. 1A and 1B, the conventional light shade 1 reflects the light from the back or from the edge to the front through the spherical reflecting surface 11. But since the light shade 1 merely reflects the light to the front without directivity, it cannot effectively concentrate the light in the specified area, such that the utilization efficiency of the light device is low and the undesired scattering light is produced. These will affect the drivers, pedestrians, and even people living in the area.

### SUMMARY OF THE INVENTION

The present invention is to provide an illuminant device and its light reflecting shade, particularly a light reflecting shade having a high directivity and capable of concentrating the light in the specified area.

To achieve the above, a light reflecting shade according to the present invention is used to reflect the light emitted from a light source. Such light reflecting shade includes a plurality of reflecting sheets forming a conoid-like structure that has a first side and a corresponding second side. The light source is disposed at the first side and the second side is a light emitting side. The central axial line of the first side is aligned or not aligned with the central axial line of the second side.

The first side is an open or closed for disposing the reflecting sheet. The first side is preferably parallel to the second side. The area of the second side is greater than that of the first side, and the first side and the second side are respectively an ellipse, a circle, a rectangle, or a polygon plane. The second side is preferably a rectangular plane having two longer edges parallel to each other and two shorter edges parallel to each other. The vertical distances from the central axial line of the first side to the two longer edges of the second side are not the same, or the vertical distances from the central axial line of the first side to the two shorter edges of the second side are not the same.

The above-mentioned reflecting sheet includes at least one engaging element for assembling the adjacent reflecting sheet. Such reflecting sheet further includes a first reflecting sheet having a clasp and a second reflecting sheet having a groove. The vertical cross section of the light reflecting shade is a trapezoid plane and the material of the reflecting sheet is preferably aluminum. The surface of the reflecting sheet is a high reflective material formed by plating or coating. The high reflective material is preferably silver.

To achieve the above, another light reflecting shade of the present invention includes a plurality of reflecting sheets forming a conoid-like structure that has a first side and a corresponding second side. The light source is disposed at the first side and the second side is a light emitting side. The second side is a non-rectangular quadrilateral plane, preferably a trapezoid plane.

To achieve the above, the illuminant device according to the present invention is arranged and assembled by at least one illuminant module. Each illuminant module includes at least one light source, at least one light reflecting shade, a substrate, and a heat sink. The light reflecting shade is disposed corresponding to the light source and includes a plurality of reflecting sheets. Each light reflecting shade has a first side and a second side. The light source is disposed at the first side and the second side is a light emitting side. The light source is disposed on the substrate and the heat sink is disposed under the substrate for heat dissipation.

The light source is preferably a light emitting diode (LED). The illuminant module further includes a power connection line, a housing, and a rubber pad. The power connection line is electrically connected to the light source. The material of the housing is preferably aluminum, and the housing is connected to the heat sink for covering the light source, substrate, and light reflecting shade. The housing further includes a transparent plate, which is preferably made of glass and disposed above the light source for passing the light therethrough. The rubber pad is disposed between the housing and the heat sink for providing the water-proof function to the light source.

The above-mentioned illuminant modules are arranged and assembled at the same plane or different planes, and are preferably assembled in an arc shape. The above-mentioned illuminant device further includes a ring-shaped frame that the illuminant modules are disposed thereon.

The above-mentioned second side is preferably a rectangular plane having two longer edges parallel to each other and two shorter edges parallel to each other. The smallest angle between the central axial line of the first side and a line extending from the center of the first side to the longer edge of the second side is greater than or equal to 25 degrees and smaller than or equal to 35 degrees. The smallest angle between the central axial line of the first side and a line extending from the center of the first side to the shorter edge of the second side is greater than or equal to 30 degrees and smaller than or equal to 60 degrees.

### BRIEF DESCRIPTION OF THE DRAWINGS

The present invention will become more fully understood from the subsequent detailed description and accompanying drawings, which are given by way of illustration only, and thus are not limitative of the present invention, and wherein:

FIGS. 1A and 1B are schematic views of a conventional hemispherical light reflecting shade;

FIG. 2A is a schematic view of an asymmetrical light reflecting shade according to a preferred embodiment of the present invention;

FIG. 2B is a edge view of FIG. 2A;

FIG. 2C is a top view of FIG. 2A;

FIGS. 2D and 2E are schematic views of the asymmetrical light reflecting shade in FIG. 2A on an illuminant device;

FIG. 3A is a schematic view of a trapezoid light reflecting shade according to a preferred embodiment of the present invention;

FIG. 3B is a edge view of FIG. 3A;

FIG. 3C is a top view of FIG. 3A;

FIG. 4A is a top view of a rectangular light reflecting shade according to a preferred embodiment of the present invention;

FIG. 4B is a edge view of a shorter edge of the rectangular light reflecting shade in FIG. 4A;

FIG. 4C is a edge view of a longer edge of the rectangular light reflecting shade in FIG. 4A;

FIG. 5A is an exploded view of an illuminant module according to a preferred embodiment of the present invention;

FIG. 5B is a schematic view of the assembled FIG. 5A;

FIGS. 6A and 6B are schematic views of the light reflecting shade in FIG. 5A; and

FIGS. 7A and 7B are schematic views of an illuminant device according to a preferred embodiment of the present invention.

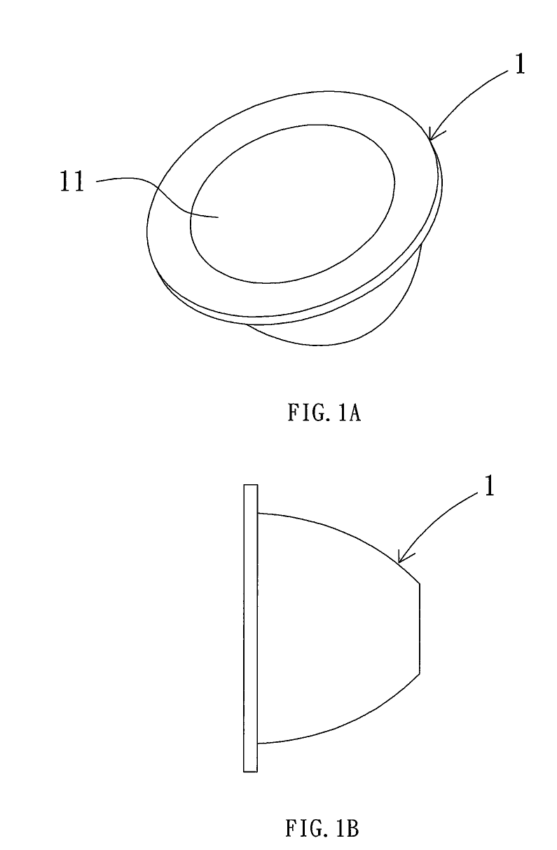

### DETAILED DESCRIPTION OF THE INVENTION

The present invention will be apparent from the following detailed description, which proceeds with reference to the accompanying drawings, wherein the same references relate to the same elements.

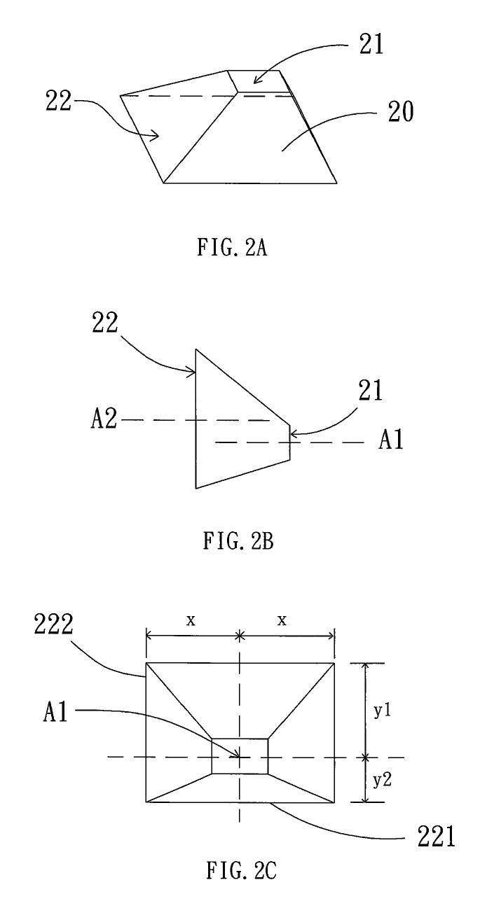

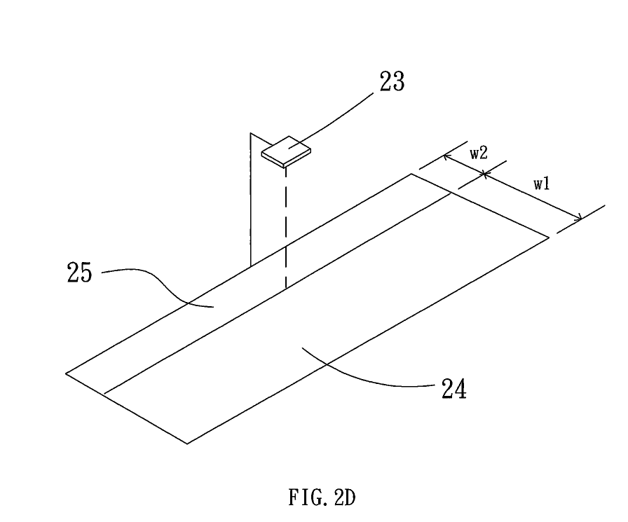

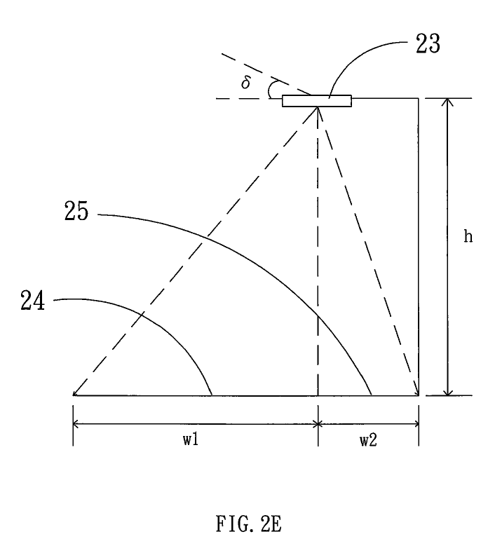

FIGS. 2A to 2C show an asymmetrical light reflecting shade according to a preferred embodiment of the present invention. FIG. 2B is a edge view of FIG. 2A and FIG. 2C is a top view of FIG. 2A. With reference to FIGS. 2A to 2C, the asymmetrical light reflecting shade includes a plurality of reflecting sheets 20 forming a conoid-like structure, or a single reflecting sheet bended to form a conoid-like structure. The conoid-like structure has a first side 21 and a corresponding second side 22. The light source is disposed at the first side 21 and the second side 22 is a light emitting side. The first and the second sides are both open, and the central axial line A1 of the first side 21 is not aligned with the central axial line A2 of the second side 22.

The above-mentioned second side is a rectangular plane having two longer edges 221 parallel to each other and two shorter edges 222 parallel to each other. The vertical distances from the central axial line A1 of the first side 21 to the two longer edges 221 of the second side 22 are respectively y1 and y2, and y1 is not equal to y2. The vertical distances from the central axial line of the first side to the two shorter edges 222 are both x, which means their vertical distances are the same. Furthermore, referring to FIGS. 2D and 2E, the asymmetrical light reflecting shade on an illuminant device 23 is shown. The illuminant device 23 is usually disposed between the street 24 and the sidewalk 25. The street width w1 plus the sidewalk width w2 is the height h of the illuminant device, i.e. w1+w2=h. The distance between the two illuminant devices is 3h. The illuminant device in the embodiment is horizontally disposed. However, the illuminant device can also be disposed in a tilt angle δ, which is preferably smaller than 15 degrees. If the area of the first side is fixed, the angle of the light toward the street width direction can be changed by controlling the lengths of y1 and y2, in which y1 is used to control the angle of the light on a side of the street 24 and y2 is used to control the angle of the light on a side of the sidewalk 25, so as to achieve the requirements of even luminance and light uniformity on the road surface. Moreover, the vertical distances from the central axial line A1 of the first side 21 to the two shorter edges 222 of the second side 22 can be changed to control the angle of the light toward the street length direction.

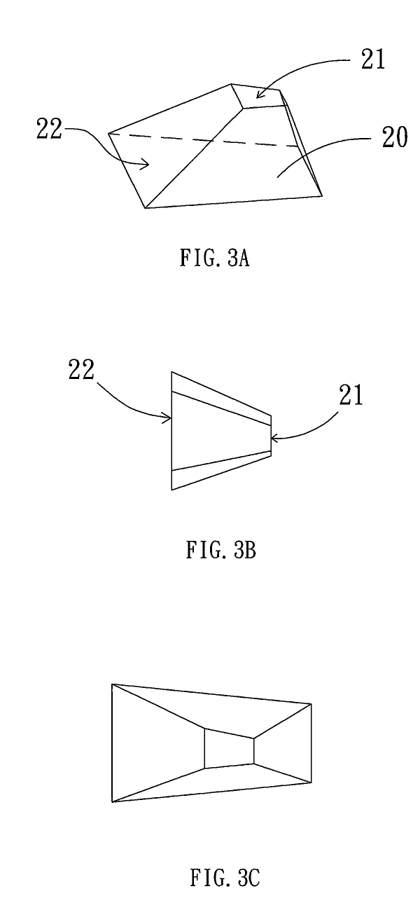

FIG. 3A shows a trapezoid reflecting shade according to a preferred embodiment of the present invention. FIG. 3B is a side view of FIG. 3A and FIG. 3C is a top view of FIG. 3A. The difference between the embodiment and the above-described asymmetrical light reflecting shade is that the first side 21 and the second side 22 are respectively a trapezoid plane. When the light of the illuminant device tilts an angle δ (δ<15°) of elevation, a part of the light will exceed the specified illuminated area. Such trapezoid light reflecting shade increases the utilization efficiency of the light device by correcting the shape of the light through four faces of the conoid-like structure of the trapezoid light reflecting shade so as to concentrate the light in the specified illuminated area.

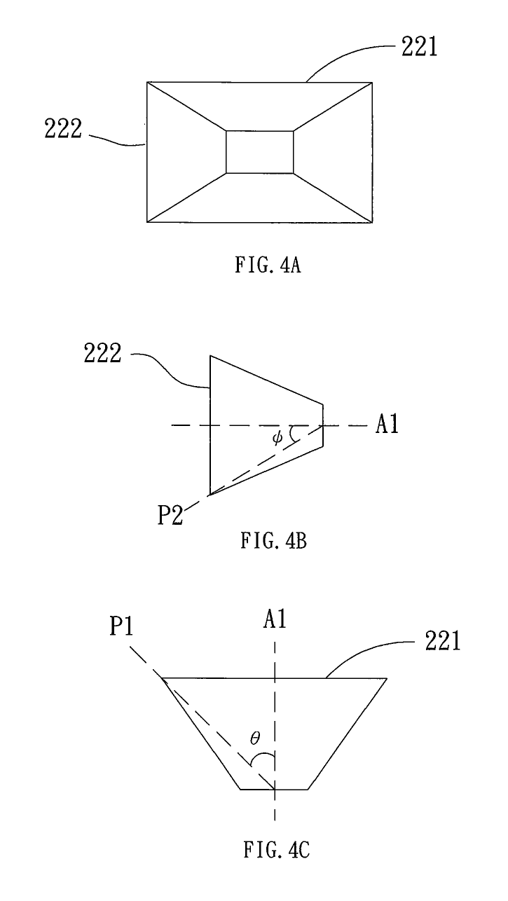

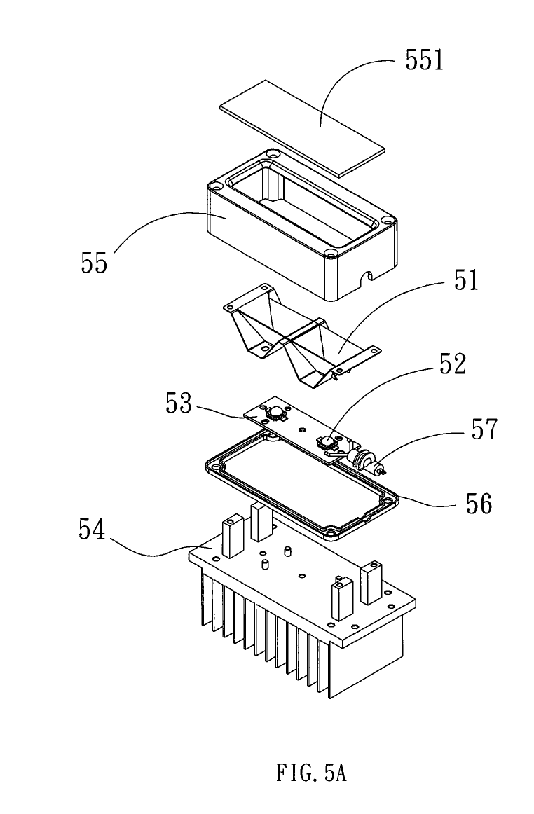

FIGS. 4A to 4C illustrate a rectangular light reflecting shade according to a preferred embodiment of the present invention. FIG. 4A is a top view of the rectangular light reflecting shade, FIG. 4B is a side view of the shorter edge of the rectangular light reflecting shade, and FIG. 4C is a side view of the longer edge of the rectangular light reflecting shade. With reference to FIGS. 4A to 4C, the difference between the embodiment and the above-described embodiment is that the first side and the second side are both rectangular planes, and the central axial line A1 of the first side is aligned with the central axial line A1 of the second side. An angle θ between the central axial line A1 of the first side and a line P1 extending from the center of the first side to the longer edge 221 of the second side is preferably 25°□θ□35°. An angle φ between the central axial line A1 of the first side and a line P2 extending from the center of the first side to the shorter edge 222 of the second side is preferably 30°□φ□60°.

In the above-mentioned embodiment, the first side can be an open side, or a closed side having a reflecting sheet disposed thereon. The first side and the second side that can be an ellipse, a circle, a rectangle, a trapezoid, a polygon, or an irregular shape depending on the actual requirement are or are not parallel to each other. The vertical cross section of the light reflecting shade is a trapezoid plane. The area of the second side is greater than that of the first side, and the reflecting sheet includes at least one engaging element for assembling the adjacent reflecting sheet to form a conoid-like structure.

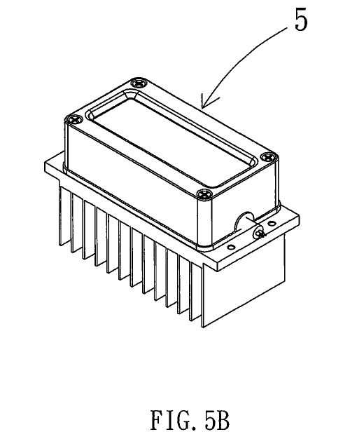

FIG. 5A is an exploded view of an illuminant module according to a preferred embodiment of the present invention and FIG. 5B is a schematic view of the assembled FIG. 5A. With reference to FIGS. 5A and 5B, the illuminant module 5 includes a light reflecting shade 51, a light source 52, a substrate 53, a heat sink 54, a housing 55, a transparent plate 551, a rubber pad 56, and a power connection line 57. The light reflecting shade 51 that is disposed corresponding to the light source 52 is comprised of a plurality of reflecting sheets. Each light reflecting shade has a first side and a second side. The light source 52 is disposed at the first side and the second side is a light emitting side. The light source 52 is disposed on the substrate 53, and the heat sink 54 is disposed under the substrate 53 for heat dissipation. The housing 55 that is connected to the heat sink 54 for covering the light source 52, substrate 53, and light reflecting shade 51 is made of aluminum. A transparent plate 551 is disposed above the housing 55 for passing the light therethrough. A heat conducting material can be attached to the surface of the substrate.

The light source 52 is a light emitting diode (LED) electrically connected to the power connection line 57. The rubber pad 56 is disposed between the housing 55 and the heat sink 54 for providing a water-proof function. The material of the light reflecting shade 51 is aluminum having a high reflective material formed by plating or coating on the surface. Such high reflective material is preferable silver.

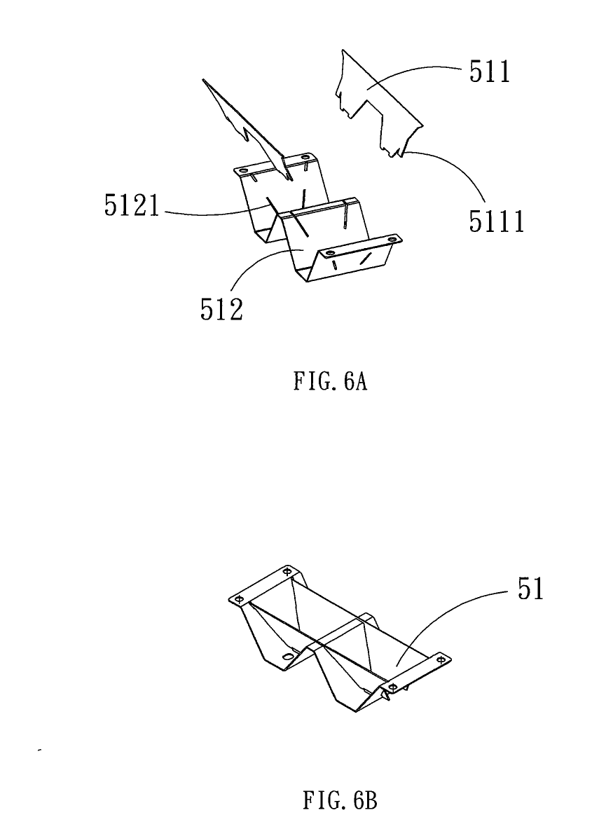

FIGS. 6A and 6B are schematic views of the light reflecting shade in FIG. 5A. The assembled structure can form two sets of light reflecting shades 51 comprised of two first reflecting sheets 511 and a second reflecting sheet 512. The first reflecting sheet 511 has a plurality of clasps 5111 and the second reflecting sheet has a plurality of grooves 5121 corresponding to the clasps 5111. The light reflecting shade 51 is formed by embedding the clasp 5111 of the first reflecting sheet 511 to the groove 5121 of the second reflecting sheet 512.

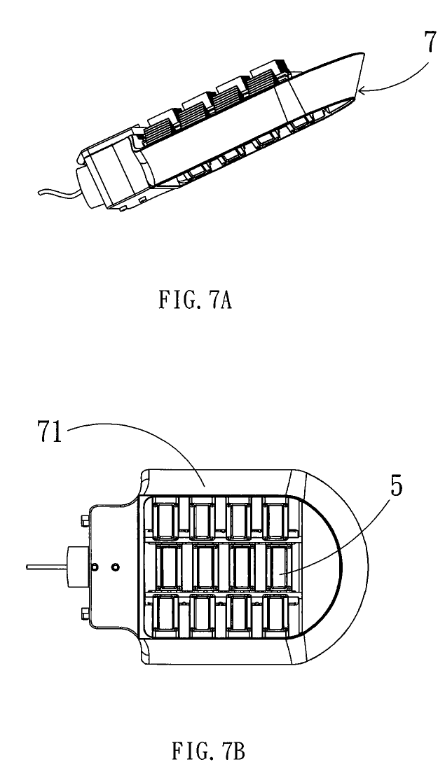

FIGS. 7A and 7B are schematic views of an illuminant device according to a preferred embodiment of the present invention. With reference to FIGS. 7A and 7B, the illuminant device includes a ring-shaped frame 71 with the plurality of illuminant modules 5 in FIG. 5B disposed thereon. The plurality illuminant modules 5 are arranged and assembled at the same plane or different planes. In the embodiment, the illuminant modules 5 are arranged in an arc shape having a three-row structure. The illuminant modules 5 in the central row are arranged horizontally, and the other two rows lean toward the center in an angle and hence an arc shape is formed. The illuminant device 7 is preferably a street lamp, a searchlight, or a projection lamp.

To sum up, the illuminant device and its light reflecting shade have high directivity that can concentrate the light in the specified area. The utilization efficiency of the light device can be enhanced by correcting the shape of the light through the faces of the conoid structure of an irregular polygon, so as to concentrate the light. With a uniform luminance, the light device helps enhance the utilization efficiency and reduce the undesired scattering light, hence decrease the number of the light sources so as to lower the cost.

Although the present invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the present invention.

What is claimed is:

1. A light reflecting shade for reflecting a light emitted from a light source, comprising:
at least one reflecting sheet forming a conoid-like structure, wherein the conoid-like structure has a first side and a second side, the light source is disposed at the first side, the second side is a light emitting side, and the central axial line of the first side is aligned or not aligned with the central axial line of the second side.

2. The light reflecting shade according to claim 1, wherein the first side or the second side has an ellipse, trapezoid, circle, rectangle, polygon, non-rectangular quadrilateral or irregular profile, and the first side is open or closed.

3. The light reflecting shade according to claim 1, wherein the second side comprises two longer edges parallel to each other and two shorter edges parallel to each other, wherein vertical distances from the central axial line of the first side to the two longer edges of the second side are not the same, or vertical distances from the central axial line of the first side to the two shorter edges of the second side are not the same.

4. The light reflecting shade according to claim 1, wherein the area of the second side is greater than that of the first side, and the first side and the second side are parallel or unparallel.

5. The light reflecting shade according to claim 1, wherein the reflecting sheet comprises at least one engaging element for forming the conoid-like structure.

6. The light reflecting shade according to claim 5, wherein the at least one reflecting sheet comprises a first reflecting sheet and a second reflecting sheet, the first reflecting sheet comprises at least one clasp, and the second reflecting sheet comprises at least one groove corresponding to the clasp.

7. The light reflecting shade according to claim 1, wherein the vertical cross section of the light reflecting shade is a trapezoid plane.

8. The light reflecting shade according to claim 1, wherein the material of the reflecting sheet is aluminum or metal, the surface of the reflecting sheet comprises a high reflective material formed by plating or coating, and the high reflective material is silver or high reflective metal.

9. The light reflecting shade according to claim 1, wherein the second side comprises two longer edges parallel to each other and two shorter edges parallel to each other, an angle between the central axial line of the first side and a line extending from the center of the first side to the longer edge of the second side is greater than or equal to 25 degrees and smaller than or equal to 35 degrees, and an angle between the central axial line of the first side and a line extending from the center of the first side to the shorter edge of the second side is greater than or equal to 30 degrees and smaller than or equal to 60 degrees.

10. A light reflecting shade for reflecting a light emitted from a light source, comprising:
at least one reflecting sheet forming a conoid-like structure, wherein the conoid-like structure has a first side and a second side, the light source is disposed at the first side, and the second side is a light emitting side and has a non-rectangular quadrilateral plane.

11. The light reflecting shade according to claim 10, wherein the second side has a trapezoid plane.

12. The light reflecting shade according to claim 10, wherein the first side is open or closed, and the first side is an ellipse, a trapezoid, a circle, a rectangle, a polygon, or an irregular profile.

13. An illuminant device assembled by at least one illuminant module, the illuminant module comprising:
at least one light source;
at least one light reflecting shade disposed corresponding to the light source and formed by at least one reflecting sheet, wherein the light reflecting shade comprises a first side and a second side, the light source is disposed at the first side, and the second side is a light emitting side;
a substrate for disposing the light source thereon; and
a heat sink disposed at one edge of the substrate for dissipating heat of the light source.

14. The illuminant device according to claim 13, wherein the illuminant module further comprises a housing connected to the heat sink for covering the light source, the substrate, and the light reflecting shade.

15. The illuminant device according to claim 14, wherein the housing further comprises a transparent plate disposed on an optical path of the light source for passing the light therethrough.

16. The illuminant device according to claim 15, wherein the material of the housing is aluminum, and the material of the transparent plate is glass.

17. The illuminant device according to claim 13, wherein the illuminant module further comprises a rubber pad disposed between the housing and the heat sink for providing a water-proof function.

18. The illuminant device according to claim 13, wherein the plurality of illuminant modules are arranged and assembled at the same plane, different planes or in arc shape.

19. The illuminant device according to claim 13 further comprising a frame having the plurality of illuminant modules disposed thereon.

20. The illuminant device according to claim 13, wherein the illuminant device is a street lamp, a searchlight, or a projection lamp.

21. The illuminant device according to claim 13, wherein the second side comprises two longer edges parallel to each other and two shorter edges parallel to each other, an angle of the light toward a street width direction is changed by controlling the vertical distances from the central axial line of the first side to the two longer edges of the second side, and an angle of the light toward the street length direction is changed by controlling the vertical distances from the central axial line of the first side to the two shorter edges of the second side.

22. The illuminant device according to claim 13, wherein the light source is a light emitting diode (LED), and the illuminant module comprises a power connection line electrically connected to the light source.

23. The illuminant device according to claim 13, wherein a heat conducting material is attached to the surface of the substrate.
